(19) United States
(12) Patent Application Publication
(10) Pub. No.: US 2021/0008664 A1
(43) Pub. Date: Jan. 14, 2021

(54) LASER WELDING OF TRANSPARENT WORKPIECES

(71) Applicant: TRUMPF Laser- und Systemtechnik GmbH, Ditzingen (DE)

(72) Inventors: Malte Kumkar, Weimar (DE); Felix Zimmermann, Leonberg (DE)

(21) Appl. No.: 17/034,126

(22) Filed: Sep. 28, 2020

Related U.S. Application Data
(63) Continuation of application No. PCT/EP2019/058717, filed on Apr. 5, 2019.

(30) Foreign Application Priority Data
Apr. 10, 2018 (DE) 102018205325.1

(51) Int. Cl. B23K 26/244; B23K 26/0622; B23K 26/082; B23K 26/57; B23K 26/08

(52) U.S. Cl. CPC B23K 26/244; B23K 26/0624; B23K 2103/54; B23K 26/57; B23K 26/083; B23K 26/082

(57) ABSTRACT

Methods and devices for laser welding of mutually overlapping workpieces by pulsed laser beams, for example, Ultrashort-pulsed (USP) laser beams, are provided. In one aspect, a method includes directing a pulsed laser beam through one workpiece onto the other workpiece and moving the pulsed laser beam in a feed direction relative to the two workpieces to produce a weld seam between the two workpieces bearing against one another. A deflection back and forth of the pulsed laser beam directed transversely or parallel to the feed direction is superposed on the pulsed laser beam moved in the feed direction.

### CROSS REFERENCE TO RELATED APPLICATIONS

This application is a continuation of and claims priority under 35 U.S.C. § 120 from PCT Application No. PCT/EP2019/058717, filed on Apr. 5, 2019, which claims priority from German Application No. 10 2018 205 325.1, filed on Apr. 10, 2018. The entire contents of each of these priority applications are incorporated herein by reference.

### TECHNICAL FIELD

The invention relates to methods and devices for laser welding of two mutually overlapping workpieces by a pulsed laser beam.

### BACKGROUND

Ultrashort-pulsed (USP) laser radiation having pulse durations of less than 500 ps is increasingly being used for material processing. The special feature of material processing using USP laser radiation resides in the short interaction time of the laser radiation with the workpiece. Owing to this short interaction time, extreme thermodynamic imbalances can be produced in the solid body, which then result in unique ablation or formation mechanisms. In this regard, for example, metals, semiconductors, dielectrics or composite materials can be ablated highly precisely with minimal heat input or formation processes of micro- or nanostructures can be induced (e.g. Gottmann, J., Hermans, M., Ortmann, J., “Digital Photonic Production of Micro Structures in Glass by In-Volume Selective Laser-Induced Etching using a High Speed Micro Scanner”, Physics Procedia 39, 2012, 534-541).

The laser welding of laser-transparent glasses or else other, with respect to the laser beam transparent, partly transparent or scattering materials by means of ultrashort laser pulses enables a stable connection without additional material use, but is limited by laser-induced transient and permanent stresses. Therefore, a multiple pass of the laser beam along the joining line of the joining partners, that is to say, along the weld seam, is usually used in order to increase the linking cross-section. In principle, the laser-induced stress can also be reduced by means of suitable laser and/or process parameters, although this can result in other disadvantages (gap bridging ability).

The background is the local melting of the material by means of ultrashort laser pulses. If ultrashort laser pulses are focused into the volume of glass, e.g., quartz glass, the high intensity present at the focus leads to nonlinear absorption processes, as a result of which, depending on the laser parameters, various material modifications can be induced. If the temporal pulse spacing is shorter than the typical thermal diffusion time of the glass, the temperature in the focus region increases from pulse to pulse (so-called heat accumulation) and can lead to local melting. If the modification is positioned in the region of the interface between two glasses, the cooling melt generates a stable connection of both glasses. On account of the local joining process, the laser-induced stresses are typically low, as a result of which even glasses that are very different thermally can be bonded. However, said stresses influence the strength and can limit the feasibility of the laser bonding. Besides the size of the modification, which depends on process parameters, e.g., the average laser power and the pulse overlap, the geometry of the weld seam also has a crucial influence on the laser-induced stresses. In this regard, a linear weld seam can predefine a preferred plane along which cracks can propagate, which is thus disadvantageous for the strength and can lead to material failure (fracture).

### SUMMARY

Implementations of the present invention can address the problem, in the case of a method of the type mentioned above, of reducing the stresses that are laser-induced in the workpieces to be welded to one another and of producing a sufficiently stable weld seam as far as possible in a single pass, and also of specifying a suitable laser processing machine.

One aspect of the invention features a method of laser welding of two mutually overlapping workpieces by a pulsed laser beam, including: directing the pulsed laser beam through an upper workpiece onto a lower workpiece, the two workpieces mutually overlapping with each other, and moving the pulsed laser beam in a feed direction relative to the two workpieces to produce a weld seam between the two workpieces abutting on one another. A deflection back and forth of the laser beam is superposed on the laser beam moved in the feed direction. For example, a scanner can be controlled to deflect the laser beam back and forth to superpose on the laser beam moved in the feed direction. The deflection back and forth of the laser beam can be effected transversely, in particular perpendicularly, or parallel to the feed direction. In this case, the deflection back and forth of the laser beam transversely to the feed direction encompasses any deflection of the laser beam which does not run parallel to the feed direction. The deflection back and forth of the laser beam perpendicularly to the feed direction can in particular also be effected in the beam propagation direction. By means of a deflection back and forth of the laser beam transversely to the feed direction, it is possible to produce a weld seam in the shape of a zigzag or serpentine line. In this case, advantageously, the laser focus is not situated at the level of the joining area, but rather in the volume of the lower or upper workpiece just below or above its joining area. In this way, a melting volume can arise which does not include the joining areas of the two workpieces.

According to the invention, the dynamic deflection of the laser beam transversely or parallel to the feed direction during the pass of the laser beam makes it possible to reduce or redistribute the stresses that are laser-induced during the welding process, with the result that a higher strength is achieved in comparison with conventional welding. In particular, the weld seam in the shape of a zigzag or serpentine line that is produced by means of the dynamic deflection of the laser beam transversely to the feed direction brings about a stress or stress birefringence that is lower on average than in the case of a rectilinear weld seam, where stress maxima occur in a manner separated from one another. Microscopic displacements (strains) on account of the change in volume of the workpiece material cannot accumulate along a preferred direction and thus cannot predefine a breaking line. Particularly in the case of non-rectilinear weld seams, it is possible to produce the required stability of the welding connection in a single pass.

The invention makes it possible to increase the strength of laser-bonded workpieces independently of whether or not the joining partners are subsequently also treated for further quality improvement. Furthermore, the effective size of the melted area can be increased, which can in turn improve the stability of the joining connection. Further advantages result from the fact that the melting volume can be increased and at the same time its geometry can be controlled more flexibly than hitherto. In this case, the advantages of this melt which is controlled in terms of volume and geometry in a single pass can be utilized with regard to both strength and throughput.

In some embodiments, at least one workpiece, in particular also the other workpiece (or the lower workpiece), is formed from glass, in particular quartz glass, from polymer, glass ceramic, crystals or combinations thereof and/or with opaque materials and has a transparency of at least 90% at the laser wavelength. In this case, this value relates to linear absorption processes of the laser beam in untreated material.

In principle, the relative movement of the laser beam in the feed direction and transversely or parallel to the feed direction can be achieved solely by movement of the workpieces, solely by deflection of the laser beam or by a combination thereof. In the latter case, preferably, the two workpieces are moved exclusively in the feed direction and at the same time the laser beam is deflected exclusively transversely or parallel to the respective feed direction. The feed velocity and the deflection velocity can be advantageously chosen such that the deflection velocity is between 0.01 times and 100 times the feed velocity. In principle, it is possible to effect the relative movement of the laser beam in the feed direction along any desired trajectory.

In one method variant, the two workpieces are moved with a constant feed velocity in the feed direction and the laser beam is deflected back and forth periodically with an identical amplitude transversely or parallel to the feed direction in order, in the former case, to produce a weld seam in the form of a regular zigzag line or a sine curve.

In this case, the welding process is based in particular on a laser beam absorption which is induced by nonlinear effects and which results in the modification threshold of the respective material being exceeded, with the result that a permanent modification of the material occurs. In this case, the parameters of all or a portion of the laser pulses are chosen such that nonlinear absorption processes occur and the modification threshold is exceeded as a result thereof. In particular, the welding process is initiated by one or more pulses whose parameters are chosen such that processes occur which are induced by nonlinear absorption and which result in permanent material modifications.

Another aspect the invention features a laser processing machine for laser welding of two mutually overlapping workpieces, of which at least one, in particular also the other, has a transparency of at least 90% at the laser wavelength, including a laser, in particular a USP laser, for generating a pulsed laser beam, in particular in the form of USP laser pulses, a scanner for deflecting the laser beam transversely or parallel to a feed direction, and a machine controller programmed to control the scanner in such a way that a deflection back and forth of the laser beam directed transversely or parallel to the feed direction is superposed on a movement of the laser beam in the feed direction.

The movement of the laser beam in the feed direction can be effected by the scanner and/or by a movement unit for moving the two mutually overlapping workpieces in a feed direction.

In some embodiments, the scanner is formed by at least one deflector (scanner mirror) which is electro-optical, acousto-optical, piezo-adjustable or based on microelectromechanical system technology.

Further advantages and advantageous configurations of the subject matter of the invention are evident from the description, the claims and the drawing. Likewise, the features mentioned above and those presented below can be used in each case by themselves or as a plurality in arbitrary combinations. The embodiments shown and described should not be understood as an exhaustive enumeration, but rather have exemplary character for outlining the invention.

### DESCRIPTION OF DRAWINGS

FIG. 1 schematically shows a laser processing machine for laser welding of two laser-transparent workpieces by means of a laser beam, the upper workpiece being partly cut away in its illustration.

FIGS. 2A and 2B show two different weld seams according to the invention on two laser-welded workpieces, the upper workpiece being partly cut away in its illustration.

FIG. 3 shows the polarization contrast intensity of a rectilinear weld seam and a zigzag weld seam on two laser-welded workpieces, in each case in a plane view of the lap joint of the two laser-welded workpieces.

### DETAILED DESCRIPTION

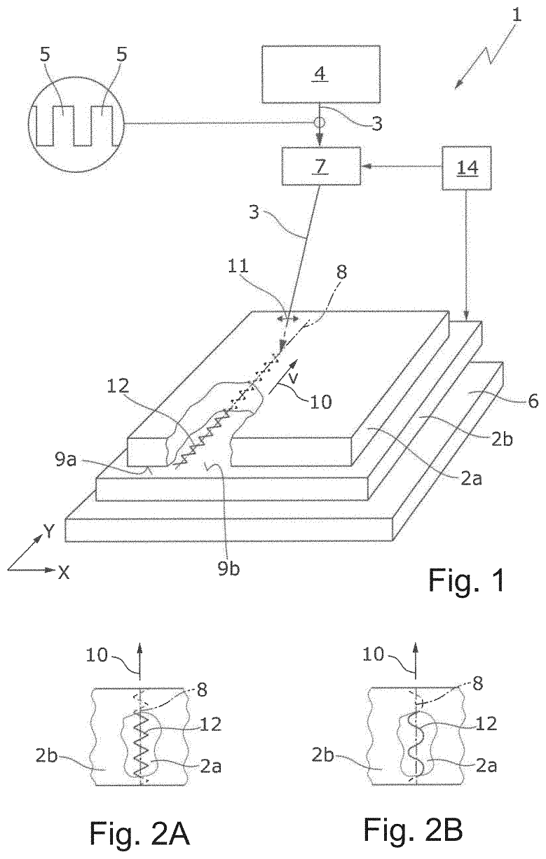

The laser processing machine 1 shown in FIG. 1 serves for laser welding of two mutually overlapping workpieces 2a, 2b by means of a laser beam 3, where at least the upper workpiece 2a in FIG. 1, in particular also the other, lower workpiece 2b, has a transparency of at least 90% at the laser wavelength and is formed for example from glass, in particular quartz glass, from polymer, glass ceramic, in a crystalline fashion or from combinations thereof and/or with opaque materials.

The laser processing machine 1 includes a USP laser 4 for generating the laser beam 3 in the form of USP laser pulses 5 having pulse durations of less than 500 ps, in particular less than 10 ps, a movement unit (e.g., a workpiece mover such as a workpiece table) 6, which is movable in the x-y-direction, for jointly moving the two workpieces 2a, 2b to be welded, and also a scanner 7 for two-dimensionally deflecting the laser beam 3 on the two workpieces 2a, 2b to be welded.

The scanner 7 is for example a microscanner (e.g., a galvanometer scanner) with a high-Na microscope objective. In this case, the USP laser pulses 5 emitted by the USP laser 4 are deflected by a galvanometer scanner 7, the beam deflection of which is imaged via a telescope (not shown) into the region of the focal plane of the microscope objective. The laser beam 3 can be deflected by the scanner 7 in two transverse axes, and the deflected laser beam 3 is imaged by means of the telescope onto the microscope objective of the scanner 7, said microscope objective being situated just in front of the workpiece to be processed. Alternatively, the beam deflection can also be effected by means of deflectors that are electro-optical, acousto-optical, piezo-adjustable or else based on microelectromechanical system (MEMS) technology.

During the laser welding of the two workpieces 2a, 2b, the laser beam 3 is directed through the upper workpiece 2a in FIG. 1 onto the lower workpiece 2b and is moved—e.g., by means of movement of the movement unit 6—relative to the two workpieces 2a, 2b along a here rectilinear feed trajectory 8 in order that the two workpieces 2a, 2b are locally melted at their joining areas 9a, 9b abutting on one another and are thus connected to one another. A deflection back and forth (double-headed arrow 11) of the laser beam 3 directed transversely, here at right angles, to the respective feed direction 10 is superposed on the laser beam 3 moved along the feed trajectory 8, in order thereby to produce a weld seam 12 in the shape of, e.g., a zigzag or serpentine line on the top side 8. In this case, advantageously, the laser focus of the focused laser beam 3 is not situated on the joining area, but rather in the volume of the second workpiece 2b near its joining area 9b. The weld seam 12 can be embodied as a regular zigzag line (FIG. 2A) or as a sine curve (FIG. 2B) as a result of the superposition of a uniform feed movement and a periodic transverse deflection of the laser beam 3.

The weld seam 12 in the shape of a zigzag or serpentine line brings about on average lower stresses than a rectilinear weld seam, where stress maxima occur in a manner separated from one another. Microscopic displacements (strains) on account of the change in volume of the workpiece material cannot accumulate along a preferred direction and thus cannot predefine a breaking line. The stresses that are laser-induced during the pass of the laser beam 3 are reduced or redistributed, with the result that a higher strength is achieved in comparison with conventional laser welding.

A deflection back and forth of the laser beam 3 directed parallel to the respective feed direction 10, instead of transversely as shown, can also be superposed on the laser beam 3 moved along the feed trajectory 8, in order thereby to produce a longitudinal weld seam (not shown) on the top side 8.

The following laser parameters can be chosen:
laser wavelength between 200 and 5000 nm,
repetition rate of the laser pulses between 1 kHz and 500 GHz,
laser pulse duration between 10 fs and 500 ps,
focusing and pulse energy such that the fluence in the focus zone is greater than 0.01 J/cm².

The modification threshold given a pulse duration of approximately 1 ps and a laser wavelength of approximately 1 μm here in the case of glass, for example, is approximately 1 to 5 J/cm² in the volume, and approximately 0.1-0.5 J/cm² at the surface.

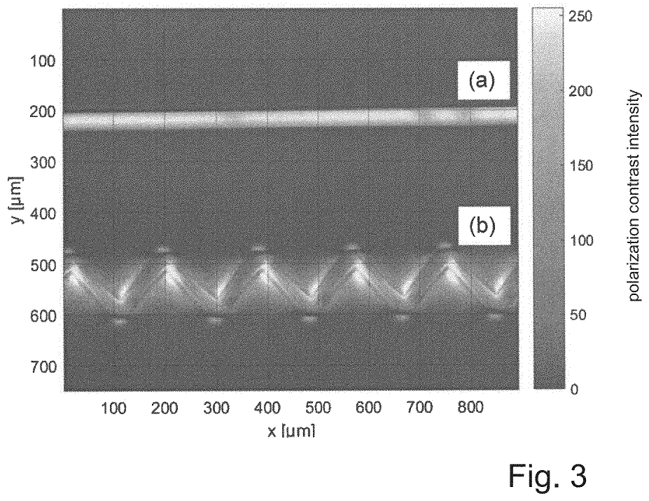

One measure of the laser-induced stresses (stress birefringence) is the polarization contrast intensity, which is illustrated in FIG. 3 by way of example for the case of a rectilinear weld seam (curve a) and the weld seam in the shape of a zigzag or serpentine line according to the invention (curve b). In the case of the rectilinear weld seam (a), the induced stress is comparably high over the entire modified region and indicates a uniform, continuous stress distribution. The weld seam (b) in the shape of a zigzag or serpentine line exhibits on average lower stress maxima with intensity peaks occurring in a manner separated from one another, as a result of which the strength of the laser-bonded connection is increased.

What is claimed is:

1. A method of laser welding of two mutually overlapping workpieces by a pulsed laser beam, the method comprising:
directing the pulsed laser beam through a first workpiece onto a second workpiece, the first and second workpieces mutually overlapping each other; and
moving the pulsed laser beam in a feed direction relative to the first and second workpieces to produce a weld seam between the first and second workpieces,
wherein a deflection back and forth of the pulsed laser beam directed transversely or parallel to the feed direction is superposed on the pulsed laser beam moved in the feed direction.

2. The method of claim 1, wherein at least one of the first workpiece or the second workpiece is formed from at least one of glass, polymer, or glass ceramic.

3. The method of claim 2, wherein the at least one of the first workpiece or the second workpiece is formed partially with an opaque material.

4. The method of claim 1, wherein at least one of the first workpiece or the second workpiece has a transparency of at least 90% at a laser wavelength of the pulsed laser beam.

5. The method of claim 1, wherein the first and second workpieces are moved exclusively in the feed direction and at the same time the laser beam is deflected back and forth exclusively transversely or parallel to the feed direction.

6. The method of claim 1, wherein the first and second workpieces are moved with a constant feed velocity in the feed direction.

7. The method of claim 1, wherein the first and second workpieces are moved with a feed velocity with acceleration in the feed direction.

8. The method of claim 1, wherein the laser beam is deflected back and forth periodically with an identical amplitude transversely to the feed direction to produce the weld seam.

9. The method of claim 1, wherein the weld seam is in a form of a zigzag line or a sine curve.

10. The method of claim 1, wherein one or more pulses of the pulsed laser beam have at least one parameter chosen such that a nonlinear absorption process occurs during the laser welding in at least one of the first workpiece or the second workpiece.

11. The method of claim 1, wherein the pulsed laser beam comprises an Ultrashort-pulsed (USP) laser beam in a form of USP laser pulses.

12. A laser processing machine for laser welding of two mutually overlapping workpieces, the laser processing machine comprising:
a laser configured to generate a pulsed laser beam;
a scanner configured to deflect the pulsed laser beam transversely or parallel to a feed direction; and
a machine controller configured to control the scanner such that a deflection back and forth of the pulsed laser beam directed transversely or parallel to the feed direction is superposed on a movement of the laser beam relative to the two mutually overlapping workpieces in the feed direction.

13. The laser processing machine of claim 12, wherein at least one of the two mutually overlapping workpieces has a transparency of at least 90% at a laser wavelength of the pulsed laser beam.

14. The laser processing machine of claim 12, wherein the laser comprises an Ultrashort-pulsed (USP) laser for generating a USP laser beam in a form of USP laser pulses.

15. The laser processing machine of claim 12, further comprising:
a workpiece mover configured to move the two mutually overlapping workpieces in the feed direction,
wherein the machine controller is configured to control the workpiece mover and the scanner such that the laser beam is moved relative to the two mutually overlapping workpieces in the feed direction and the deflection back and forth of the laser beam directed transversely or parallel to the feed direction is superposed on the movement.

16. The laser processing machine of claim 12, wherein the machine controller is configured to control the scanner such that a weld seam is produced between the two mutually overlapping workpieces that abut on one another.

17. The laser processing machine of claim 16, wherein the weld seam is in a form of a zigzag line or a sine curve.

18. The laser processing machine of claim 12, wherein the machine controller is configured to control the scanner such that a focus of the pulsed laser beam is in a volume of one of the two mutually overlapping workpieces, the volume being below or above a joining area of the one of the two mutually overlapping workpieces.

19. The laser processing machine of claim 12, wherein one or more pulses of the pulsed laser beam have parameters chosen such that a nonlinear absorption process occurs during the laser welding in at least one of the two mutually overlapping workpieces.

20. The laser processing machine of claim 12, wherein the scanner is formed by at least one of an electro-optical deflector, an acousto-optical deflector, a piezo-adjustable deflector, or a deflector based on microelectromechanical system (MEMS).
